(19) United States
(12) Patent Application Publication
(10) Pub. No.: US 2004/0114807 A1
(43) Pub. Date: Jun. 17, 2004

(54) Statistical representation and coding of light field data

(76) Inventors: Dan Lelescu, Morgan Hill, CA (US); Frank Jan Bossen, San Jose, CA (US)

Correspondence Address: Tadashi Horie, Brinks Hofer Gilson & Lione, NBC Tower, Suite 3600, P.O. Box 10395, Chicago, IL, 60610, US

(21) Appl. No.: 10/318,837

(22) Filed: Dec. 13, 2002

(51) Int. Cl. G06K 9/72

(52) U.S. Cl. 382/229; 382/232

(57) ABSTRACT

A method of representing light field data by capturing a set of images of at least one object in a passive manner at a virtual surface where a center of projection of an acquisition device that captures the set of images lies and generating a representation of the captured set of images using a statistical analysis transformation based on a parameterization that involves the virtual surface.

### BACKGROUND OF THE INVENTION

1. Field of the Invention

The present invention relates to the field of imaging and, in particular, the field of manipulating light field data.

2. Discussion of Related Art

Considerable work has been dedicated in the past to the goal of generating realistic views of complex scenes from a limited number of acquired images. In the context of computer graphics methods, the input for rendering techniques includes geometric models and surface attributes of the scene, along with lighting attributes. Despite significant progress in modeling the scene and in the creation of virtual environments, it is still very difficult to realistically reproduce the complex geometry and attributes of a natural scene, aside from the great computational burden required to model and render such scenes in real time. These considerations are further amplified for the case of modeling and rendering of dynamic natural scenes.

Image-based representation and rendering (IBR) has emerged as a class of approaches for the generation of novel (virtual) views of the scene using a set of acquired (reference) images. Pre-cursor approaches can be tracked to texture mapping, texture morphing, and the creation of environment maps. Image-based approaches for representation and rendering come with a number of advantages. Most importantly, such methods make it possible to avoid most of the computationally expensive aspects of the modeling and rendering processes that occur in traditional computer graphics approaches. Also, the amount of computation per frame is independent from the complexity of the scene. Disadvantages are related to the acquisition stage where it might be difficult to set up the cameras to correspond to the chosen parameterization. The image data may have to be re-sampled, using a costly process that introduces degradation with respect to the original data. Additionally, the spatial sampling must be fine enough so as to limit the amount of distortion when generating novel views, thus implying a very large amount of image data. The problem is compounded for the case of dynamic scenes (video).

The idea of capturing the flow of light in a region of space can be formalized through the introduction of the plenoptic function as a way to provide a complete description of the low of light into a region of a scene by describing all the rays visible at all points in space, at all times, and for all wavelengths, thus resulting in a 7D parameterization. A discussion of the plenoptic function is made in “The Plenoptic Function and the Elements of Early Vision”, by E. H. Adelson and J. R. Bergen, MIT Press, 1991. The dimensionality of the light field can be reduced by giving up degrees of freedom (e.g., no vertical parallax) as disclosed in “Rendering with Concentric Mosaics,” by H. Y. Shum and L. W. He, in Proceedings of SIGGRAPH '99, 1999, pp. 299-306. By fixing certain parameters in the plenoptic function, different imaging scenarios can be created (e.g., omnidirectional imaging at a fixed point in space). Issues related to the optimal sampling and reconstruction in a multidimensional signal processing context have been discussed in both “Generalized Plenoptic Sampling”, by C. Zhang and T. Chen, TR AMP 01-06, Carnegie Mellon University, Advanced Multimedia Processing Lab, September 2001 and “Plenoptic sampling”, by J. X. Chai, X. Tong, S. C. Chan, and H. Y. Chum, “in Proceedings of SIGGRAPH 2000, 2000. Alternative parameterizations of the light fields have been introduced in “Rendering of Spherical Light Fields”, by I. Ihm, R. K. Lee, and S. Park, in 5th Pacific Conference on Computer Graphics and Applications, 1997, pp. 59, 68, “Uniformly Sampled Light Fields”, by E. Camahort, A. Lerios, and D. Fussell, in Eurographics Rendering Workshop 1998, 1998, pp. 117-130 and “A Novel Parameterization of the Light Field”, by G. Tsang, S. Ghali, E. L. Fiume, and A. N. Venetsanopoulos, in Proceedings of the Image and Multidimensional Digital Signal Processing '98, 1998. These parameterizations were introduced for reasons related to sampling uniformity, coverage of all possible directions with a single light field instead of multiple light field “slabs”, and for compression purposes. For example, by fixing the time parameter and assuming that the wavelength is constant along a ray, the dimensionality of the representation can be reduced to five dimensions such as described in “Plenoptic Modeling: An Image-Based Rendering System”, by L. McMillan and G. Bishop, in Proceedings of SIGGRAPH 95, Los Angeles, August 1995, pp. 39-46. Under the assumption of free space (space which is free of occluders in the region of the scene), the dimensionality can be further reduced to four dimensions.

Various parameterizations of 4D plenoptic function have been introduced. For example, both the so-called Light Field and Lumigraph representations allow a 4D parameterization of the plenoptic function by geometrically representing all the rays in space through their intersections with pairs of parallel planes. An example of the Lumigraph representation is described in “The Lumigraph”, by S. J. Gortler, R. Grzeszczuk, R. Szeliski, and M. F. Cohen, in Computer Graphics Proceedings Annual Conference Series SIGGRAPH'96, New Orleans, August 1996, pp. 43-54. The Lumigraph representation is similar to the Light Field representation, but makes some additional assumptions about the geometry of the scene (knowledge about the geometry of the object). An image of the scene represents a two dimensional slice of the light field. In order to generate a new view, a two dimensional slice must be extracted and re-sampling may be required. In a ray space context the image corresponding to a new (synthesized) view of the scene is generated pixel by pixel from the ray database. Two steps are required: 1) computing the coordinates of each required ray, and 2) re-sampling the radiance at that position. For each corresponding ray the coordinates of the ray's intersection with the pair of planes in the parameterization are computed. For re-sampling, pre-filtering and aliasing issues must be addressed.

The Light Field representation, along with the Lumigraph representation mentioned previously, allow a 4D parameterization of the plenoptic function, by representing all the rays in space through their intersections with pairs of parallel planes (which is only one of a number of parameterization options). An illustration of the light field parameterization idea is shown in FIG. 1. In a physical acquisition system implementing this parameterization, the camera can occupy discrete positions on a grid in the camera plane. Both the Lumigraph and Light Field representations can be viewed as including pairs of two-dimensional image arrays, correspondingly situated in the image and the focal planes.

An example of the Light Field representation is described “Light Field Rendering”, by M. Levoy and P. Hanrahan, in Computer Graphics Proceedings SIGGRAPH'96, New Orleans, August 1996, pp. 31-42. In the original Light Field parameterization of the plenoptic function, the light detector, such as a camera, can be modeled as being placed at discrete positions in a plane and receiving rays that intersect the other corresponding plane of the pair (focal plane). To each camera position in the camera plane corresponds an acquired image of the scene situated at the corresponding focal plane. The acquired image is formed on the planar image sensor of the camera. As the camera (more precisely, its center of projection) occupies discrete positions in the camera plane, the corresponding two dimensional array of images acquired is therefore situated in a so-called image plane.

The amount of data generated by the Light Field representation is extremely large, as the representation relies on over-sampling in order to assure the quality of the generated novel views of the scene. Given the acquisition model characteristics, it is expected that there exists a high degree of correlation among the images forming the two dimensional array corresponding to different acquisition positions and comprising the image plane described above. Initial methods for compressing the data by using vector quantization followed by Lempel-Ziv (LZ) entropy coding, or intra-frame (JPEG) coding of the images have obtained limited success in this respect. Better compression performance has been obtained by applying straightforward extensions of motion-compensated prediction (MPEG-like methods) to the compression of light field data. Although the compression of the two dimensional arrays of images in the image plane can be approached similarly to the case of video coding, certain distinctive characteristics of the light field representations can produce different requirements. Exploiting characteristics of the human visual system (such as sensitivity to distortions, spatial and temporal masking) that are used in coding video images may not be used in this case. Also, predictive coding schemes such as MPEG pose a problem for random access given the dependencies of pixels and dispersion of referenced samples in memory.

In the past, the use of an MPEG-like coder in Light Field representation work was examined. During this examination, the light field data was coded using vector quantization (VQ) followed by Lempel-Ziv entropy coding. The motivation for using this approach versus a modified MPEG coding technique was related to the already discussed factors of sample dependency and access characteristics of a predictive scheme. Considering only the rate distortion measure, the encoding performance using vector quantization and Lempel-Ziv coding is low. Also, the data for the entire light field were encoded, thus necessitating a full decoding of the light field in order to allow interactive rendering, when only the relevant portion of the light field data should be decoded for generating a virtual camera view.

Another approach to light field data encoding was also employed by using a JPEG coder applied to each of the images in the 2D array in an image plane of the representation as described in “Compression of Lumigraph with Multiple Reference Frame (MRF) Prediction and Just-In-Time Rendering”, by C. Zhang and J. Li, in Proceedings of IEEE Data Compression Conference, March 2000, pp. 253-262. Intra-coding of the images in the two-dimensional array comprising an image plane allows for direct access when data must be decoded for visualization. Better compression was achieved and interactive rendering can be attained by decoding only the images that contain the data required for the synthesis of a novel view.

In order to exploit the redundancy among the images in the two dimensional array, motion-compensated MPEG-like encoding schemes have also been applied to the coding of light field data resulting in superior performance in terms of compression compared to the JPEG coding as described in “Compression of Lumigraph with Multiple Reference Frame (MRF) Prediction and Just-In-Time Rendering”, by C. Zhang and J. Li, in Proceedings of IEEE Data Compression Conference, March 2000, pp. 253-262, “Adaptive Block-Based Light Field Coding”, by M. Magnor and B. Girod, in Proceedings of 3rd International Workshop on Synthetic and Natural Hybrid Coding and Three-Dimensional Imaging, Greece, September 1999, pp. 140-143 and “Multi-hypothesis Prediction for Disparity-compensated Light Field Compression”, by P. Ramanathan, M. Flierl, and B. Girod, in International Conference on Image Processing (ICIP 2001), 2001. The two dimensional array of images were encoded using a number of reference I (intra-coded) pictures uniformly distributed throughout the two dimensional array, and P (predicted) pictures that are encoded with respect to the reference I pictures. Moreover, multiple reference frame (MRF) encoding of P pictures could be used, such that each P picture used a number of neighboring I reference pictures for the prediction process in the manner shown in FIG. 2. A multiple reference predictive approach can further increase the dependencies of data in the compressed representation and the issue of access to the required reference samples for synthesizing a novel view. In general, it can be expected that data from a few I or P images from the image plane has to be used in order to provide the information necessary for obtaining a novel view (via interpolation) in the rendering phase. Given the proportion of I and P coded images in an image plane, most of the images that must be decoded to provide data for interpolating a new virtual view will be of type P. Therefore, in the general case, the different multiple “anchor” I images that are required for the reconstruction of the necessary P images must be accessed and decoded. As the viewpoint changes, different P images will have to be decoded and image data contained in them interpolated. Accordingly, some, if not all, of the new I frames serving as reference for the new P images need to be decoded.

Also, in some past attempts the prediction process exploited the fact that for the case of the images in the image plane of the light field representation, the motion compensation was viewed as one-dimensional (disparity-wise). Thus, a disparity compensation was performed given the fact that the camera positions in the camera plane are known. For computer generated objects the advantage was that the disparity was known exactly.

As disclosed in “Compression of Lumigraph with Multiple Reference Frame (MRF) Prediction and Just-In-Time Rendering”, by C. Zhang and J. Li, in Proceedings of IEEE Data Compression Conference, March 2000, pp. 253-262, an encoding algorithm was used that is very similar to MPEG for coding the light field data. The object imaged in that paper was a statue's head rendered from the visible human project. Multiple reference frames (MRF) were used, and P pictures were restricted to refer only to I pictures in the image plane. At 32.5 dB, the MRF-MPEG encoding scheme achieved 270:1 compression ratio with respect to the original data size, and at 36 dB a compression ratio of 170:1.

One of the best past approaches strictly regarding rate-distortion performance is disclosed in “Adaptive Block-Based Light Field Coding”, by M. Magnor and B. Girod, in Proceedings of 3rd International Workshop on Synthetic and Natural Hybrid Coding and Three-Dimensional Imaging, Greece, September 1999, pp. 140-143. In this approach, an MPEG-like coding of light field data was employed. The motion compensation became a one-dimensional “disparity compensation” for the case of light fields. Multiple macroblock coding modes were selected under the control of a Lagrangian rate-control functional. The light field data of a Buddha-like object was coded. The reported peak signal to noise ratio (PSNR) is the average luminance PSNR over all light field images (corresponding to one image plane). However, the original data size used in the compression ratio computation incorporated both the luminance and the chrominance information. As a direct consequence, the compression factor reported incorporated an additional 2:1 compression (in the absence of any other compression on the chrominance signals), if the down-sampling of the chrominance components was executed, as it is customary. In this context, the coding algorithm achieved a 0.03 bpp (bits per pixel) compression at 36 dB for the Buddha light field (for 6.3% of the images being I pictures).

As disclosed in “Multi-hypothesis Prediction for Disparity-compensated Light Field Compression”, by P. Ramanathan, M. Flierl, and B. Girod, in International Conference on Image Processing (ICIP 2001), 2001, a multiple-hypothesis (MH) approach and a disparity compensation for coding the light field data are used, this time operating only on the luminance (Y) data.

In another approach, a 4D-Discrete Cosine Transform (DCT) was applied to the 4D ray data, and 4D-DCT in conjunction with a layered decomposition of the of images, for the compression of light field data as described in “Ray-based Approach to Integrated 3D Visual Communication”, T. Naemura and H. Harashima, in SPIE, Vol.

CR76, November 2000, pp. 282-305. The 4D-DCT used together with a layered model gave the better results. A signal to noise ratio measurement was used to present the results. A JPEG or MPEG2 coding of the light field data gave relatively poor results. In comparing the JPEG and MPEG2 coding to 4D-DCT, it appears that the 4D-DCT technique can potentially offer advantages only if combined with the layered texture approach. For general scenes however, given their natural visual complexity it was still a very difficult task to produce such layered decompositions, a problem well-recognized in connection with image segmentation.

In yet another approach, a representation and compression of surface light fields was presented as disclosed in “Light Field Mapping: Efficient Representation and Hardware Rendering of Surface Light Fields”, by W.-C. Chen, J.-Y. Bouguet, M. H. Chu, and R. Grzeszczuk, ACM Transactions on Graphics, Proceedings of ACM SIGGRAPH 2002, vol. 21, no. 3, pp. 447-456, July 2002. This approach partitioned the light field data over surface primitives (triangles) on the surface of an imaged object. The resulting data (the vertex light fields) corresponding to each primitive on the surface of the object was approximated using either a Principal Component Analysis (PCA) factorization or a non-negative matrix factorization (NMF). The size of the triangles was chosen empirically, as the compression ratio is related to the size of the primitives (triangles). The redundancy over the individual light field maps was reduced using vector quantization (VQ). The resulting codebooks were stored as images. Note that for real objects, an active imaging technique was utilized. The object was painted (with removable paint) to facilitate scanning, and a light pattern was projected onto the object (i.e., using an active imaging technique). Also, a mesh model was obtained for the imaged object (to generate the surface primitives), which is a difficult task for passively acquired natural objects whose surface properties can be very complex. Given the use of vector quantization codebooks for groups of triangle surface maps and view maps, they would need to be transmitted in a communication context. With a camera plane grid resolution of 32×32=1024, coding performance was reported by using vertex light field PCA, and NMF as approximation methods in conjunction with vector quantization and S3TC hardware compression. Taking only the vertex light field approximation using the PCA, and varying the number of approximation terms (2-4 terms) for a first object (statuette), at 27.63 dB, a compression ratio of 63:1 was obtained, and at 26.77 dB (with fewer approximation terms) a 117:1 ratio was given. For a second object (a bust), at 31.04 dB, a 106:1 compression ratio resulted. The highest compression ratio reported for the case of using the vertex LF PCA+VQ corresponded to the second object and was equal to 885:1 for a peak signal to noise ratio (PSNR) of 27.90 dB.

### SUMMARY OF THE INVENTION

One aspect of the present invention regards a method of representing light field data by capturing a set of images of at least one object in a passive manner at a virtual surface where a center of projection of an acquisition device that captures the set of images lies and generating a representation of the captured set of images using a statistical analysis transformation based on a parameterization that involves the virtual surface.

The above aspect of the present invention provides the advantage of creating a very efficient representation of the light field data, while enabling direct random access to information required for novel view synthesis, and providing straightforward decoding scalability.

The present invention, together with attendant objects and advantages, will be best understood with reference to the detailed description below in connection with the attached drawings.

### BRIEF DESCRIPTION OF THE DRAWINGS

FIG. 1 schematically illustrates a known ray parameterization in a Light Field representation;

FIG. 2 schematically shows an image plane where multiple anchor images are accessed in accordance with a known multiple reference frame encoding process;

FIG. 3 schematically shows an embodiment of an imaging system in accordance with the present invention;

FIG. 4 schematically shows an image plane where images in the two dimensional array are accessed by sampling the image plane uniformly in accordance with an embodiment of a PCA representation performed in accordance with the present invention;

FIG. 5 schematically shows an image plane where local representation areas are divided out of the image plane in accordance with an embodiment of a PCA representation performed in accordance with the present invention;

FIG. 6 schematically shows an embodiment of an encoding process in accordance with the present invention;

FIG. 7 shows an eigenvalue magnitude versus rank graph for a global PCA representation process in accordance with the present invention;

FIG. 8 shows a peak signal to noise ratio versus data size graph for a global PCA representation process in accordance with the present invention;

FIG. 9 shows a peak signal to noise ratio versus data size graph for both global iterative and training PCA representation processes in accordance with the present invention;

FIG. 10 shows a peak signal to noise ratio versus data size graph for a global iterative and local PCA representation processes in accordance with the present invention;

FIGS. 11 (a)-(c) show a first example of sample light field image data, where the original image along with its PCA-reconstructed versions in accordance with the present invention are indicated;

FIGS. 12(a)-(c) show a second example of sample light field image data, where the original image along with its PCA-reconstructed versions in accordance with the present invention are indicated; and

FIGS. 13(a)-(c) show a third example of sample light field image data, where the original image along with its PCA-reconstructed versions in accordance with the present invention are indicated.

### DETAILED DESCRIPTION OF THE INVENTION

For illustration purposes, the present invention will be described hereinafter based on embodiments regarding Light Field representations accounting for the more general context (no assumptions about the geometry of the scene), and on the particular plane parameterization described previously. Extensions to other parameterizations can be made since the input data used in the present invention is represented by the images acquired at discrete camera positions. With the above guidelines in mind, the present invention regards the representation, coding and decoding of light fields that use the optimality properties of Principal Component Analysis (PCA) along with the characteristics of the light field data. The present invention strikes a balance between two opposing requirements specific to coding of light fields, i.e., the necessity of obtaining high compression ratios usually associated with using motion compensated methods, and the objective of reducing or eliminating dependencies between various images in an image plane of the representation (i.e., facilitating random access to the image data).

The present invention uses PCA to produce both a transformation and a compression of the original light field to facilitate savings in the number of transform coefficients required to represent each image in the two dimensional arrays corresponding to the image planes of the parameterization, while maintaining a given level of distortion. The light field PCA representation approach operates on the two dimensional array of images in each of the image planes of the parameterization. Any image from the two dimensional array in an image plane of the representation can be directly reconstructed and used, by simply utilizing its subspace representation and the PCA subspace description defined by the eigenvectors selected, for the purpose of generating a virtual view of the scene. Only such images which contain pixels relevant for synthesizing the required novel view are reconstructed and used, thus enabling an interactive rendering process. Therefore, the present invention combines the desirable random access features of non-predictive coding techniques for the purpose of ray-interpolation and the synthesis of novel views of the scene, with a very efficient representation and compression.

The present invention also regards a rate-distortion approach for selecting the dimensionality of the PCA subspace which is taken separately for each of the image planes of the light field representation. This approach is based on the variation that exists in the visible scene structure and complexity as the viewpoint changes. Images in some of the image planes of the parameterization might require a lower-dimensional PCA representation subspace compared to those in other image planes. The PCA subspace dimensionality for each of the image planes can be selected adaptively, and additionally made subject to a global constraint in terms of the total dimension of the PCA representation subspace for the entire light field parameterization. Lastly, a ranked subset of the eigenvector set constituting the PCA subspace representation can be used in conjunction with the PCA transformed image data for a scalable decoding of the light field data.

Each of the above aspects of the present invention is described mathematically below where, without loss of generality, the original plane parameterization of Light Fields discussed previously is used. In more general parameterizations, the image acquisition takes place at discrete sampling points on a parameterized surface that need not be planar. At a minimum, the process described below requires a first surface associated with the capturing of images and a second surface spaced from the first surface where the two surfaces are used for parameterization of the light rays.

For example, the object 100 to be imaged is imagined to be inscribed within/circumscribed by a virtual polyhedron, such as a cube 102, wherein virtual surfaces 104a-f of the cube 102 define the focal planes of the light field parameterization 106a-f. The center of projections of the cameras are positioned at discrete positions on the virtual surfaces 108a-f that lie parallel with surfaces 104a-f, respectively. For illustration purposes, only surface 108a and camera 106a are shown. In this scenario, the cameras 106a-f act as two dimensional arrays of detectors that collect image data at the above-mentioned sampling points. These images are collected in the image plane of the light field representation. In any parameterization the sets of acquired images of the scene situated at the focal distance can represent the input to our algorithm. Note that the cameras acquire an image of the object in a passive manner since the object is not treated in any way prior to imaging to enhance the image acquisition process (i.e., passive image acquisition).

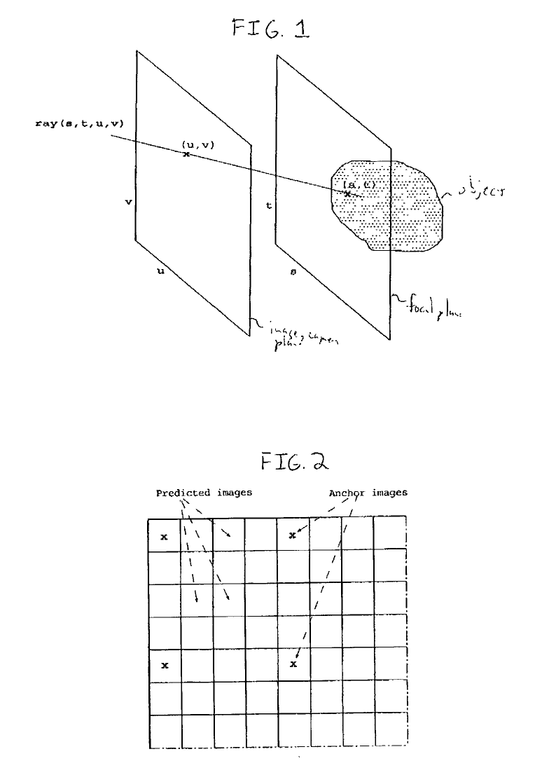

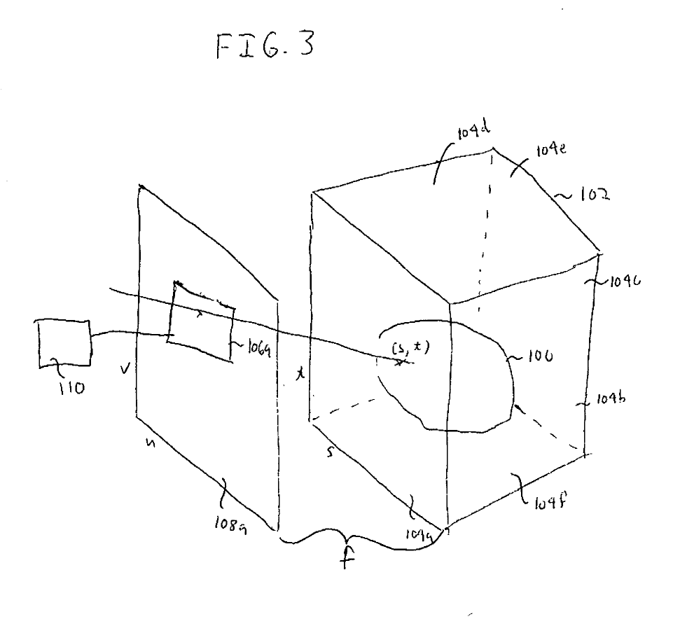

Consider now the surface 108a and its corresponding camera 106a as exemplary of the other surfaces and cameras. In this case, the surface 108a is deemed the imaging plane and is one of the two planes in the parameterization described previously with respect to FIG. 1. The camera 106a captures a two dimensional array of images of size m×n in the image plane and such images represent the input data sent to an image data processor 110 that performs a PCA representation and analysis in accordance with the present invention. Prior to their use, each of the original images in the image plane is lexicographically ordered resulting in a set of data vectors Xₖ, having dimensionality N×1, where N is the number of pixels in an image and k indexes the image in the set and the total number of such vectors is L=m×n (corresponding to the number of images in the two dimensional array in the image plane). Obviously, the total amount of image data available from the image plane is quite large. Accordingly, one of the objects of the present invention is to reduce the amount of image data by approximating the original image space by a much smaller number M of eigenvectors. Principal Component Analysis methods are used to analyze and transform the original image data into a lower dimensional subspace as it will be described below.

According to a Principal Component Analysis method to be used in the present invention, let P be an N×L data matrix corresponding to a set of L data vectors with dimension N×1. Next, deterministic estimates of statistical variables are obtained by taking the matrix C×PP^{T} to be an estimate of the correlation matrix of the data. Let Xₖ denote a data vector (column) of matrix P. A direct Principal Component Analysis (PCA) finds the largest M<L eigenvalues and corresponding eigenvectors of C. The transformed representation Yₖ of an original data vector Xₖ is Yₖ=Φ^{T}_{M}Xₖ, where Φ_{M} is the eigenmatrix formed by selecting the most significant M eigenvectors eᵢ, i=1, . . . , M corresponding to the largest M eigenvalues:

Φ_{M}=[e₁;e₂; . . . e_{M}]

Assuming that N>>L is very large, the size of matrix C is also large, which would result in computationally intensive operations using a direct PCA determination. As described in “Efficient calculation of primary images from a set of images”, by Murakami H. and Kumar V. in IEEE Transactions on Pattern Analysis and Machine Intelligence, vol. PAMI-4, pp. 511-515, (5), 1982, an efficient approach is to consider the implicit correlation matrix \tilde{C}=P^{T}P. The matrix C is of size L×L, which is much smaller than the size of C. The determination of the first M<L largest eigenvalues \tilde{λ}, and corresponding eigenvectors \tilde{e}ᵢ of \tilde{C} is faster than the direct computation of the first M eigenvalues and eigenvectors of C by the previous approach. The relationship between the two sets of corresponding eigenvalues and eigenvectors of C and \tilde{C} is such that the first M<L eigenvalues \tilde{λ}ᵢ, and eigenvectors eᵢ of C can be exactly found from the M<L largest eigenvalues and eigenvectors of \tilde{C} as follows:

λᵢ=\tilde{λ}ᵢ

eᵢ=\tilde{λ}ᵢ^{-1/2}P\tilde{e}ᵢ

where \tilde{λ}₁, \tilde{e}ᵢ are the corresponding eigenvalues and eigenvectors of \tilde{C}. The eigenvectors \tilde{e}ᵢ of \tilde{C}=P^{T}P are given by the right singular vectors of P, determined using SVD (Singular Value Decomposition). Similarly, the eigenvalues e, are obtained from the singular values given by the SVD of P. This approach can be used in the context of a training sample representation of the vector set, where a number J<L of vectors are selected as a representative sample of the full set, the corresponding PCA representation is computed as presented above for the set of size J, and the resulting subspace represented by M<J eigenvectors is used to represent the full vector set. Evidently, this approach depends on the degree to which the selected training sample is representative of the entire vector set.

If the number L of vectors in the set is large, , an alternative iterative approach for computing approximations of the M largest eigenvalues and corresponding eigenvectors of C can also be used such as described in “Efficient calculation of primary images from a set of images”, by Murakami H. and Kumar V. in IEEE Transactions on Pattern Analysis and Machine Intelligence, vol. PAMI-4, pp. 511--515, (5), 1982. It is assumed that the data vectors are processed sequentially. The algorithm is initialized by direct computation of at most M significant eigenvectors of an initial selected set of (M+1) data vectors. Evidently, fewer eigenvectors can be retained (K<M) for the representation. Only the M eigenvectors corresponding to the largest eigenvalues are retained at every stage of the iteration (M constitutes the final dimensionality of the PCA representation). For every new input vector processed, the M eigenvectors computed in the previous step are refined. After the last iteration, the set of M retained eigenvectors is normalized.

With the above analysis in mind, different approaches for transforming the original image set in an image plane of the Light Field parameterization using Principal Component Analysis (PCA) are possible. The images in the two dimensional array forming an image plane can each be vectorized as described above, thus resulting in a vector set corresponding to the original image set in the image plane. For example, the entire vector set can be considered globally, or the vector set can be further partitioned according to some criteria based on a-priori knowledge about the characteristics of the data set (in this case, based on the camera configuration), and a local analysis can be applied to each vector subset. In addition, the PCA representation can be determined using a direct, representative (training) sample, or iterative approach as will be described below. For the case of a direct approach used for the statistical analysis and representation of the light field data using Principal Component Analysis, all the vectors in the set are utilized for the direct computation of the transform. Evidently, this approach may become impractical when the cardinality of the vector set is large. For the other two PCA representation approaches, a sample selection process takes place in the two dimensional array of images. The sample selection is performed either for the purpose of providing a representative sample for a training sample-based representation, or in order to initialize the iterative approach. Although a uniformly-distributed set of image samples are selected from the two dimensional array (e.g., on a rectangular grid) in an image plane of the light field representation in the examples that follow, the actual sample distribution is flexible.

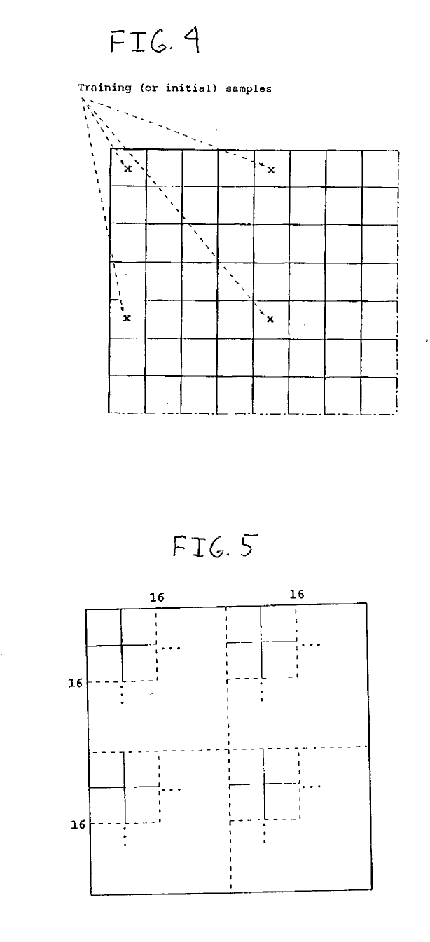

Regarding considering the original vector set globally, the entire two dimensional array of images in an image plane, such as corresponding to surface 108a, is considered for analysis. If the vector set size L is too large to allow for a direct PCA approach, a representative sample PCA method can be used. First, a training subset of J<L sample vectors taken from the entire vector set is selected. The training sample in this case can be selected uniformly from the two dimensional array of images as shown in FIG. 4 with the cardinality of the training set subject to a representation dimensionality constraint. By using the implicit method for the determination of the PCA transformation using a training sample, the M<J largest eigenvalues and the corresponding eigenvectors of this subset can be found. The retained M most significant eigenvectors represent an approximating subspace for the entire original vector space of size L. Therefore, each of the original image data vectors Xk is represented by the corresponding transformed vectors Yₖ of dimensionality M×1 in the manner shown below:

Yₖ=Φ_{M}^{T}Xₖ,

where Φ_{M} is the determined eigenmatrix.

In the case of a training sample approach used for the representation of the entire image space, the quality of the representation depends on how well the representative set incorporates the features of the entire image space. A uniformly-distributed selection process might be replaced by an adaptive selection of the training sample for improved performance.

An alternative to using a training sample for the PCA representation is to use an iterative PCA algorithm. Although for initialization purposes an initial J <L sample of vectors must be selected from the entire set, this approach eventually uses all the data vectors in the set for determining their final PCA representation, by iteratively refining the representation subspace. For the selection of the initial set of vectors used to provide a first approximation (or the initialization) of the PCA representation, the same uniform vector sampling pattern can be applied at the level of the two dimensional array of vectors, similarly to the previous case. Subsequently, each remaining vector in the set is processed and the PCA representation is iteratively refined until the entire vector set has been processed. Compared to the training sample approach, the iterative algorithm may provide an improvement in the quality of the representation, as it uses the entire vector set to determine the final representation.

Whether utilizing the training sample approach or the iterative approach, the eigenspace description provided by the retained eigenvectors in the eigenmatrix Φ_{M}, and the coordinates (transform coefficients) of each image contained in the image plane in this space represented by the corresponding vector Yₖ, are required for the reconstruction of the images. Using the orthonormality property of the PCA transform, a reconstructed vector (image) is obtained as follows:

\hat{X}ₖ=Φ_{M}Yₖ

Similarly to the previously described example of processing the entire two dimensional array of images in an image plane, a local PCA representation can be performed by partitioning the two dimensional array into multiple areas. One possible division of the image plane is shown in FIG. 5. The number of image vectors required for representation in each of these areas is Mᵢ, subject to the constraint [symbol] ᵢMᵢ=M, where M is the dimensionality of the representation for the entire image plane considered. These areas can be determined based on the a-priori knowledge about the sampling of the surface onto which the camera is placed (in this case a rectangular grid for each of the image planes). In each of the areas of an image plane a local PCA can be performed utilizing the direct, training sample, or iterative approach. The selection of a particular method to be applied locally depends on the dimensionality Lᵢ of the corresponding local vector set ( [symbol] ᵢLᵢ=L), and the desired representation performance.

The eigenspace description provided by the retained eigenvectors in the corresponding eigenmatrix Φᵢ and the coordinates of each image from the local set in this space (its transform coefficients) represented by the corresponding vector Yₖ, are required for the reconstruction of the images in each of the local areas. The reconstructed vector (image) in a local analysis area i is obtained similarly to the previous case:

\hat{X}ₖ=ΦᵢYₖ

The PCA representation data for an image plane includes the collection of PCA data generated for each of the local representation areas in the image plane.

In addition to the representation efficiency of the original light field data, the present invention enables two additional desirable properties related to the light field decoding, rendering, and scalability aspects. Under the proposed representation, for rendering, only the light field data that is necessary for generating of a specific view is decoded, by directly decoding only the required images corresponding to the two dimensional array generated in any image plane of the parameterization. This method essentially provides random access to any of the needed images in an image plane. The context necessary for performing this operation is offered by the availability of the eigenvector description of the original image space in the image plane (i.e., the eigenmatrix), along with the transformed image data corresponding to each of the images in the two dimensional array in the image plane. Similarly, the scalability of the representation is facilitated by the fact that, depending on the existing capabilities for rendering, only a subset of the available eigenvector set corresponding to an image plane can be utilized along with the image transform data in order to reconstruct the images which contain the data necessary for the generation of a novel view.

The PCA representation data that needs to be transmitted and reconstructed is coded using quantization and entropy coding. For simplicity, the coding is performed using a JPEG encoder. The data which must be coded includes the eigenvectors spanning the PCA representation subspace(s), as well as the transformed vectors corresponding to the representation of each original vector (image) in the determined lower-dimensional PCA subspace. For reconstruction, these data are then input to an entropy decoder and inverse quantizer (using a JPEG decoder), followed by the inverse transformation given in Eq. 2 or Eq. 3, depending on whether the global or local representation approach is used. In terms of coding of the eigenvectors and the transformed image vectors, better results can be obtained by using dedicated quantization, and entropy coding tables adapted to the statistics of the data generated using this approach.

Each of the retained eigenvectors is mapped back into a corresponding two dimensional matrix of values through inverse lexicographic ordering (thus forming an “eigenimage”). Each of these eigenimages are then coded individually using the JPEG coder. One option is to code each of the eigenimages with the same quality settings for the JPEG coder. However, given the decreasing representation significance of the ranked eigenvectors according to the magnitude of the corresponding eigenvalues, the retained eigenimages are preferably coded with a decreasing quality setting of the JPEG coder corresponding to the decrease in the rank of the eigenvector. Thus, the first eigenimage is coded with higher quality than the second, etc. The JPEG encoder used utilizes a quality-of-encoding scale reflective of the quantization step setting ranging from 1 to 100, with 100 representing the highest quality. The quality setting utilized for coding the retained eigenimages according to rank is shown in Table I below.

TABLE I
QUALITY SETTINGS FOR EIGENIMAGE CODING

| | | | | | | |
|---|---|---|---|---|---|---|
| Rank | 1 | 2 | 3 | 4 | 5 | 6+ |
| | (most significant) | | | | | |
| JPEG | 95 | 90 | 80 | 40 | 40 | 20 |
| Quality Setting | | | | | | |

An alternative scheme would entail setting the quality of the eigenimage encoding by utilizing the values of their corresponding eigenvalues and using an analytical function that models the dependency of the quantization step as a function of eigenvector rank.

The transformed image vectors Yₖ of size M×1, are also encoded using the JPEG encoder as follows. All the vectors Yₖ are gathered in a matrix S of size M×L, where each column of S is represented by a vector Yₖ:

S=[Y₁Y₂ . . . Y_{L}]

Each line of S is a vector of size 1×L, and from a geometrical point of view it represents the projection of each of the original images in the set onto an axis (eigenvector) of the representation subspace. Thus, each of the lines of S are inverse-lexicographically mapped back into a two dimensional “image” (matrix) which in turn is encoded using the JPEG encoder. However, for further efficiency, the resulting image corresponding to the first line in S (projection onto the first eigenvector) is encoded separately. All the other resulting images are concatenated and encoded as a unique two dimensional image using a JPEG coder. This procedure is illustrated in FIG. 6.

In the discussion to follow, simulations employing the concepts of the present invention are performed using data obtained from the light field representations available online at www graphics.stanford.edu/software/lightpack/lifs.html, which utilize the plane parameterization discussed previously. It is noted that the type of light field data used in other works cited herein is similar to the simulations discussed herein and with each other and regard light fields corresponding to a single imaged object. Thus, in the cases where the type of image data is similar but not exactly the same, general comparisons are made, we report the results presented in the corresponding references, and a general comparison can be made.

In the simulations, the input data includes m×n, (m=n=32) arrays of images in each of the image planes of the representation, that are part of the light field data corresponding to the Buddha light field available at www graphics.stanford.edu/software/lightpack/lifs.html. For illustration, the simulations are performed on the images corresponding to one plane of the light field representation. A similar approach is applied to each plane of the representation. Thus, the total number of images corresponding to an image plane of the representation is L =1024. Each of the images in the image plane is of size 256×256. Only the luminance information corresponding to the images from an image plane of the light field representation is used for simulations. Thus, the total original image data size corresponding to an image plane is 64 MBytes. After lexicographic ordering of each of the images in an image plane, the full set of image data vectors will include L=1024 vectors, each of size N=65536 (=256×256). The simulations are performed using Matlab™ v6.1., by MathWorks, Inc.

For the case of a direct approach used for the statistical analysis and representation of the light field data using Principal Component Analysis, all the vectors in the set are utilized for the direct computation of the transform. This approach may become impractical when the cardinality of the vector set is large and thus a direct PCA computation is too costly. For the other two PCA approaches, the representative (training) sample and iterative approaches, a sample selection process has to take place in the two dimensional array of images, as previously described. This is performed either for the purpose of providing a representative sample for a training sample-based representation, or in order to initialize the iterative approach. Although a uniformly-distributed set of image samples is selected from the two dimensional array (e.g., on a rectangular grid) for the simulations discussed, the actual sample distribution chosen is flexible.

For the case of the iterative PCA method used for simulations, a number J =256 sample vectors are selected from the full vector set (L=1024 vectors), accounting for a uniformly-spaced 16×16 two dimensional array of samples, and they are used to initialize the representation subspace for use with the iterative algorithm as previously described. These samples are selected to be uniformly distributed spatially throughout the two dimensional array of images, although different spatial sample distributions can be used. After performing the PCA on the J vectors selected, a number M<J eigenvectors are retained in the initial step (as well as in all the following steps of the iteration). Thus, M represents the dimension of representation subspace. For the simulations discussed, M takes values from the set {32, 64, 128}.

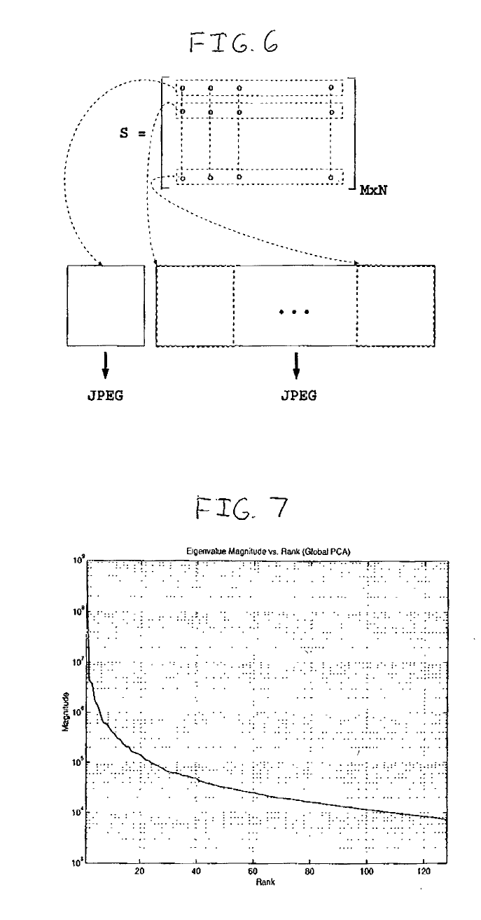

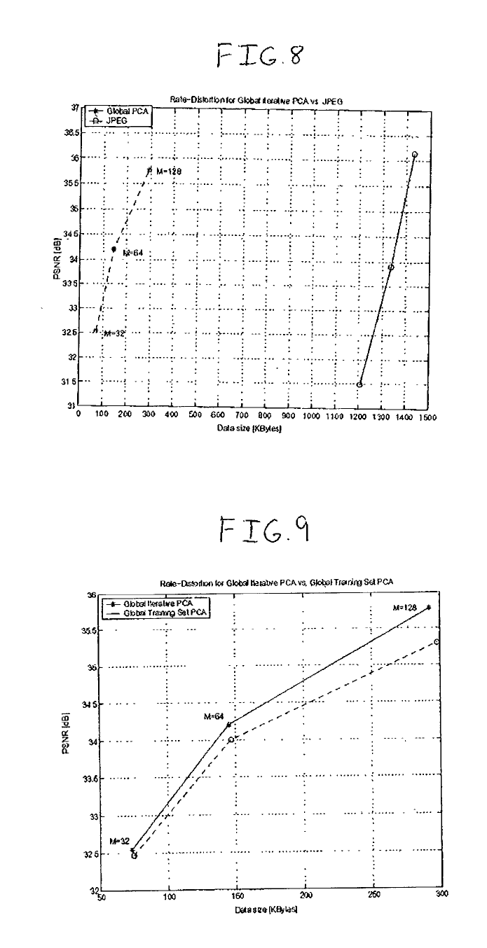

Subsequently, each remaining image data vector from the set is processed to refine the PCA representation comprising the M retained eigenvectors, until all the image vectors have been taken into account. The resulting PCA representation data includes the final retained M eigenvectors and each transformed original image vector Yₖ. The retained eigenvectors form the eigenmatrix Φ_{M} that is used to transform each of the original image vectors Xₖ according to Eq. 2. The behavior of the ranked eigenvalues magnitude for M=128 retained eigenvectors is illustrated in FIG. 7 and illustrates the rapid drop in eigenvalue magnitude and the decrease in significance of the corresponding eigenvector with increasing rank.

The resulting transformed vectors Yₖ along with the retained M eigenvector description of the space are quantized and entropy coded using a JPEG encoder, as previously described. The results of the representation and encoding of the light field image data using a global PCA representation followed by a JPEG coding of the PCA data are shown in Table II below. The Table also contains the results of a separate full JPEG coding of the light field data using Matlab's baseline JPEG coding. The rate-distortion coding results for different dimensionality PCA representation subspaces are illustrated in FIG. 8.

TABLE II
GLOBAL PCA REPRESENTATION AND CODING RESULTS

| | PCA | | | | JPEG | |
|---|---|---|---|---|---|---|
| | Data Size [Kbytes] | | | | Data | |
| Number of | Eigen- | | | PSNR | Size | PSNR |
| Eigenvectors | vectors | Coeff. | Total | [dB] | [KBytes] | [dB] |
| 32 | 59.5 | 13.3 | 72.8 | 32.55 | 1206 | 31.49 |
| 64 | 119 | 26 | 145 | 34.2 | 1336 | 33.91 |
| 128 | 241 | 51.3 | 292.3 | 35.77 | 1431 | 36.14 |

While still considering the global representation case, a training sample PCA approach can alternatively be taken for the representation of the image data in the image plane, as compared to the iterative PCA approach described above. In this case, a number J of training samples (vectors) are selected from the entire set of original image vectors. These samples are selected to be uniformly distributed throughout the vector set, similarly to the previous case (J=256), accounting for a uniformly spaced 16×16 two dimensional array of training samples). From the resulting PCA eigenvectors obtained by applying the PCA transform to the J sample vectors, a subset of M<J most significant eigenvectors is retained. This subset constitutes the PCA representation of the original image data set. The number M of retained eigenvectors spanning the representation subspace is selected from the set of values {32, 64, 128} for the simulations discussed. The resulting transformed vectors Yₖ along with the retained M-eigenvector description of the space are coded using a JPEG encoder, similarly to the previous case. The cost in bits and the PSNR of the encoding results are given in Table III below.

TABLE III
TRAINING SAMPLE PCA REPRESENTATION
AND CODING RESULTS

Training Sample PCA

| Number of | Data Size [KBytes] | | | |
|---|---|---|---|---|
| Eigenvectors | Eigenvectors | Coeff. | Total | PSNR [dB] |
| 32 | 60.7 | 13.4 | 74.1 | 32.47 |
| 64 | 120 | 26.6 | 146.6 | 34.0 |
| 128 | 245 | 53 | 298 | 35.3 |

The rate-distortion results of the training sample representation and encoding are shown in FIG. 9. As expected, the global iterative PCA performs better than the training sample based PCA approach, given the better description of the representation subspace obtained by using all the vectors in the set.

For the case of representing the light field data using a set of local representations, the two dimensional array of images in the image plane is spatially-partitioned into local areas where the PCA representation is determined. For the case of four two dimensional arrays of size 16×16 images in the image plane, each array is represented using the same number of Mᵢ, i={1, . . . , 4} local eigenvectors, where M=4×Mᵢ. Different number of eigenvectors can of course be assigned to each area depending on some criterion, subject to the constraint of having a total number M of eigenvectors per image plane.

Similar to the case of global representation, for each of the local areas (two dimensional arrays) in the image plane, a representative sample PCA approach or an iterative approach could be applied. However, if the size of the two dimensional arrays of images considered (vector set cardinality) is small enough, a direct PCA can be performed thus giving better performance. In this case, since the size of the two dimensional local image arrays was chosen to be 16×16, the cardinality of each of the corresponding original vector set is L=256. A direct PCA approach was performed for each of the four local two dimensional arrays of images in the divided image plane. The same number Mᵢ of retained eigenvectors in each of the local arrays was taken from the set of values Mᵢε{8, 16, 32} for a corresponding total eigenvector count of M=4 ×Mᵢ, Mε{32, 64, 128}.

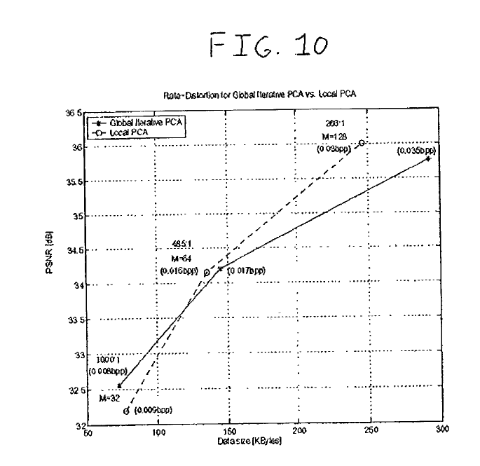

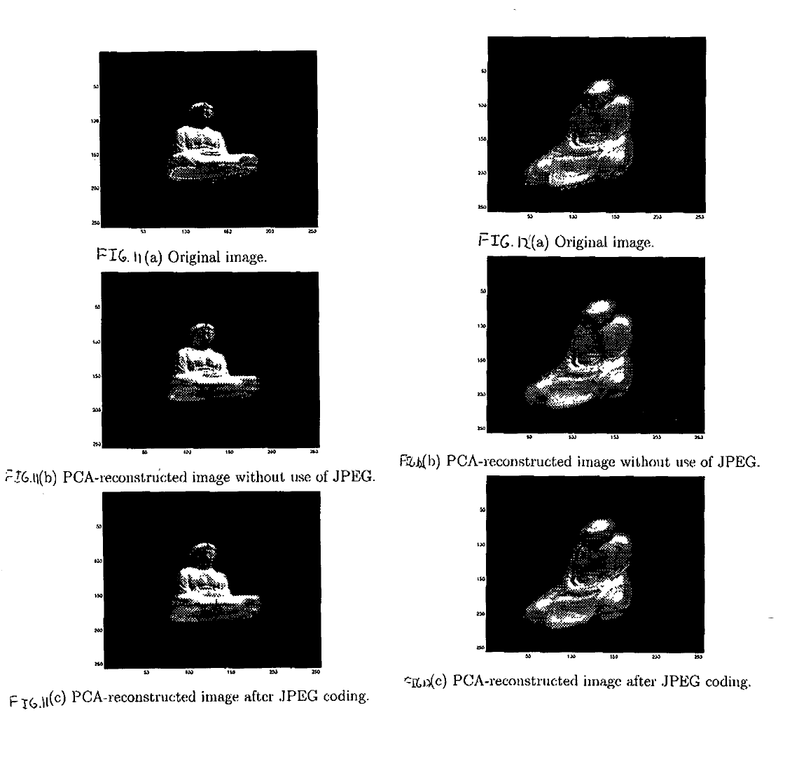

The results of the local representation and light field data encoding are given in Table IV below, and illustrated in FIG. 10, where they are compared to the results of the global representation.

TABLE IV
LOCAL PCA REPRESENTATION AND CODING RESULTS

| Number of | | Local | Local | Local | Local | |
|---|---|---|---|---|---|---|
| Eigenvectors | | PCA 1 | PCA 2 | PCA 3 | PCA 4 | Overall |
| 32 | Eig. Data [KB] | 16.8 | 18.4 | 17.6 | 17.9 | 70.7 |
| | Transf. Data [KB] | 1.61 | 1.56 | 1.62 | 1.54 | 6.33 |
| | PSNR [dB] | 31.29 | 32.82 | 31.3 | 33.36 | 32.19 |
| 64 | Eig. Data [KB] | 29.4 | 31.5 | 33.7 | 30.8 | 125.4 |
| | Transf. Data [KB] | 2.56 | 2.42 | 2.61 | 2.47 | 10.6 |
| | PSNR [dB] | 33.23 | 34.88 | 33.14 | 35.36 | 34.15 |
| 128 | Eig. Data [KB] | 55.2 | 58.2 | 57.1 | 58.1 | 228.6 |
| | Transf. Data [KB] | 4.45 | 4.18 | 4.63 | 4.32 | 17.58 |
| | PSNR [dB] | 35.01 | 36.88 | 34.93 | 37.22 | 36.01 |

The local approach gives better performance when the total number M of eigenvectors retained for the representation becomes larger. As shown in FIG. 10, as the dimensionality of the representation approaches M=64, the local description of the image plane with a correspondingly larger number of “local” eigenvectors M₁ becomes better than the global PCA representation using the M= [symbol] ᵢMᵢ global eigenvectors. At 36 dB, the local PCA representation and coding adds another 30% compression compared to the global representation. This trend accentuates as the number of eigenvectors is increased, indicating that for higher data rates (and higher PSNR) a local PCA representation should be chosen over a global one. It is interesting to further explore the adaptation of such local representations to a partitioning based on characteristics of areas of the image plane, and the use of variable-dimensionality subspaces for the corresponding local PCA representations. The local PCA representation can also reduce “ghosting” effects due to the inability of the linear PCA to correctly explain image data.

As seen in FIGS. 8 and 10, the PCA approach achieves much better performance relative to the JPEG-only coding of the light field data. The PCA-based representation and coding also compares favorably strictly in terms of rate-distortion performance in the higher compression ratios range to MPEG-like encoding algorithms applied to the light field data, indicating similar or better performance to that of modified MPEG coding techniques. Compression ratios ranging from 270:1 to 1000:1 are obtained. Better results can be obtained by using a higher quality JPEG encoder to code the PCA data and eigenvectors, and by tailoring the entropy coding to the statistics of the PCA transform data. In addition to the rate-distortion performance, the light field coding approach in accordance with the present invention offers the additional benefits related to the other factors specific to light field decoding and rendering. These factors include the predictive versus non-predictive aspects of encoding in terms of random access, visual artifacts, and scalability issues. A straightforward scalability feature is directly provided by the characteristics of the representation, and enabled by the utilization of a ranked subset of K<M available eigenvectors along with the correspondingly truncated transformed image vector, for image reconstruction by the decoder.

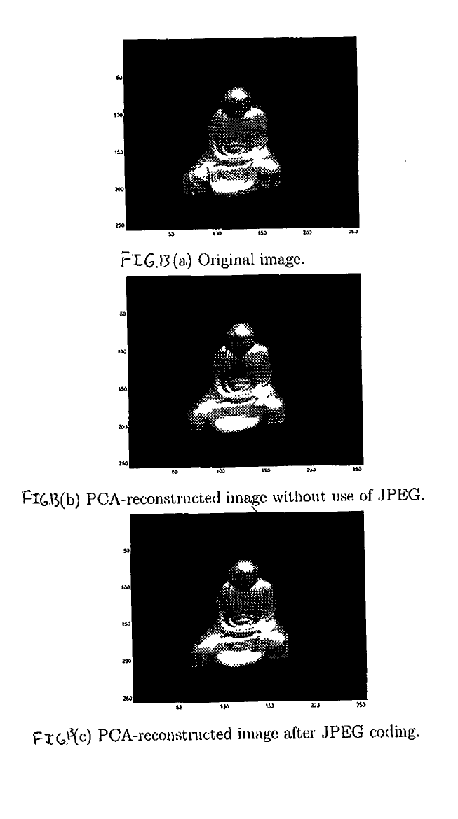

Sample light field image data is shown in FIGS. 11-13, where the original image along with its PCA-reconstructed versions are indicated. Both the PCA-reconstruction using the uncoded and JPEG-coded PCA data are shown to separate the effect of the JPEG encoder used from the PCA transformation effects. Reconstructed images at compression ratios of around 300:1 are shown. As noted above, a more up-to-date JPEG coder would make an important contribution to the performance of the encoding (also in terms of blocking artifacts). It should also be noted that the original images have a “band” of noise around the outer edge of the statue, which is picked up in the encoding process.

The foregoing description is provided to illustrate the invention, and is not to be construed as a limitation. Numerous additions, substitutions and other changes can be made to the invention without departing from its scope as set forth in the appended claims. It is a natural extension of the present invention to use an Independent Component Analysis (ICA) in place of the Principal Component Analysis (PCA). The determination of the ICA subspace for representation is done according to the methodology specific to that transformation. The description of the processes of the present invention using an Independent Component Analysis is similar to that given previously for PCA where the terms PCA and ICA are interchangeable. a topic of interest that may be applicable to the present invention is the development of techniques which allow the locally-adaptive, variable-dimensionality selection of representation subspaces in the planes of the parameterization. While the determination of the local areas of support for the local PCAs can be pre-determined, an alternative would be to use Linear Discriminant Analysis (LDA) to determine the subsets of images in an image plane, which constitute the input to the local PCAs. An extension of the representation approach to different parameterizations of the plenoptic function can be performed. Since the retained eigenvectors represent the dominant part of the PCA representation data, better coding approaches can be created to further increase the coding efficiency. Also, extensions of the light field coding to the case of representing and coding dynamic light fields can be done in a straight forward manner by processing the sequence of images comprising the image planes of the light field representation, captured at different points in time.

We claim:

1. A method of representing light field data, the method comprising:
capturing a set of images of at least one object in a passive manner at a virtual surface where a center of projection of an acquisition device that captures said set of images lies; and
generating a representation of said captured set of images using a statistical analysis transformation based on a parameterization that involves said virtual surface.

2. The method of claim 1, wherein said statistical analysis transformation is a principal component analysis.

3. The method of claim 1, wherein said statistical analysis transformation is an independent component analysis.

4. The method of claim 1, wherein said virtual surface is a plane.

5. The method of claim 1, wherein said parameterization involves a second virtual surface spaced from said virtual surface.

6. The method of claim 4, wherein said parameterization involves a second virtual surface that is parallel to said virtual surface.

7. The method of claim 1, wherein said representation is generated by a single global principal component analysis applied to said set of images captured at said virtual surface.

8. The method of claim 1, further comprising:
ordering pixels of each image of said sets of images; and
creating a corresponding set of vectors that are used to generate said representation.

9. The method of claim 1, further comprising determining dimensionality of a PCA representation subspace associated with said representation.

10. The method of claim 9, wherein said dimensionality is pre-determined.

11. The method of claim 9, wherein said determining is based on visual characteristics of said set of images.

12. The method of claim 1, wherein said statistical analysis transformation is a direct principal component analysis.

13. The method of claim 1, wherein said statistical analysis transformation is a training sample principal component analysis.

14. The method of claim 1, wherein said statistical analysis transformation is a training sample independent component analysis.

15. The method of claim 13, wherein said determining comprises selecting a uniformly distributed sample of said set of images to be used by said training sample principal component analysis.

16. The method of claim 13, wherein said determining comprises selecting a nonuniformly distributed sample of said set of images to be used by said training sample principal component analysis.

17. The method of claim 13, wherein said determining comprises:
initially selecting J vectors that are used for said training sample principal component analysis;
determining a PCA representation based on said training sample principal component analysis;
generating at most J eigenvectors;
retaining M eigenvectors of said J eigenvectors, wherein M J; and
applying said M eigenvectors to generate said representation.

18. The method of claim 1, wherein said statistical analysis transformation is an iterative principal component analysis.

19. The method of claim 18, wherein said determining comprises selecting a uniformly distributed sample of said set of images to be used by said iterative principal component analysis.

20. The method of claim 18, wherein said determining comprises selecting a nonuniformly distributed sample of said set of images to be used by said iterative principal component analysis.

21. The method of claim 18, wherein said determining comprises:
a) determining an initial PCA representation based on an initial sample set of eigenvectors of said set of images;
b) generating an initial set of M eigenvectors;
c) performing an iteration with all of said M eigenvectors and an original vector from said set of images excluding said sample set and generating a new set of eigenvectors;
d) repeat step c) until all original vectors have been used during said iteration step c) so as to generate a final set of M eigenvectors; and
e) applying said final set of M eigenvectors to generate said representation.

22. The method of claim 1, wherein said representation is generated by a set of local PCA representation subspaces that correspond to a set of local areas of said virtual surface.

23. The method of claim 22, further comprising determining dimensionality of each one of said local PCA representation subspaces.

24. The method of claim 23, wherein said determining is made subject to a constraint imposed on a total dimensionality of said virtual surface.

25. The method of claim 22, wherein said set of local PCA representation subspaces are direct PCA representation subspaces.

26. The method of claim 22, wherein said set of local PCA representation subspaces are training sample PCA representation subspaces.

27. The method of claim 22, wherein set of local PCA representation subspaces are iterative PCA representation subspaces.

28. The method of claim 22, wherein said local areas each have the same area.

29. The method of claim 22, wherein said local areas are selected based on geometry of an imaging device at said virtual plane.

30. The method of claim 22, wherein said local areas are selected based on a linear discriminating analysis applied to images associated with said virtual surface.

31. The method of claim 22, wherein said set of local PCA representation subspaces have variable dimensionality.

32. The method of claim 31, wherein said variable dimensionality is selected based on rate-distortion measures.

33. The method of claim 1, wherein said representation is generated by a set of local ICA representation subspaces that correspond to a set of local areas of said virtual surface.

34. The method of claim 1, further comprising coding eigenvector data associated with images in said virtual surface.

35. The method of claim 34, wherein said coding comprises using inverse lexicographic ordering of said eigenvector data to generate corresponding eigenimages.

36. The method of claim 35, further comprising adjusting coding of said eigenimages based on rankings of said eigenimages.

37. The method of claim 36, wherein said adjusting comprises using a predetermined adjustment.

38. The method of claim 36, wherein said adjusting comprises using an eigenvalue magnitude-driven analytic function.

39. The method of claim 1, further comprising coding PCA or ICA transformed image vectors associated with each image of said set of images in said virtual surface.

40. The method of claim 39, further comprising gathering said transformed image vectors as columns of a matrix S.

41. The method of claim 40, further comprising mapping each row of said matrix into a two dimensional matrix through inverse lexicographic ordering.

42. The method of claim 41, further comprising:
a) coding said two dimensional matrix corresponding to a first row of said matrix S, and denoted by A; and b) coding a matrix B formed by concatenating said two dimensional matrices corresponding to all rows of matrix S except said first row of matrix S.

43. The method of claim 34, further comprising controlling scalability by coding a limited number of said eigenvectors and correspondingly truncated transformed image vectors corresponding to said set of images.

44. The method of claim 3, further comprising coding ICA basis vector data.

45. The method of claim 3, further comprising coding ICA transformed image vectors associated with each image of said set of images in said virtual surface.

46. The method of claim 34, further comprising transmitting coded eigenvector data based on said coding.

47. The method of claim 42, further comprising transmitting coded transformed vector data based on said coding.

48. The method of claim 34, further comprising decoding eigenvector data based on said coding.

49. The method of claim 42, further comprising decoding transformed vector data based on said coding.

50. The method of claim 48, further comprising reconstructing an image from decoded transformed vector data and said decoded eigenvector data using an inverse PCA transformation

51. The method of claim 50, further comprising randomly accessing and reconstructing any image associated with said virtual surface.

52. The method of claim 50, wherein said reconstructing involves using a subset of said decoded eigenvector data for scalability.

53. The method of claim 44, further comprising transmitting coded basis vector data based on said coding.

54. The method of claim 42, further comprising transmitting coded transformed image vector data based on said coding.

55. The method of claim 44, further comprising decoding basis vector data based on said coding.

56. The method of claim 42, further comprising decoding transformed image vector data based on said coding.

57. The method of claim 55, further comprising reconstructing an image from decoded transformed vector data and said decoded basis vector data using an inverse ICA transformation.

58. The method of claim 56, further comprising reconstructing an image from said decoded transformed vector data using an inverse ICA transformation.

59. The method of claim 58, further comprising randomly accessing and reconstructing any image associated with said virtual surface.
